(19) United States
(12) Patent Application Publication
(10) Pub. No.: US 2026/0358569 A1
(43) Pub. Date: Nov. 12, 2026

(54) APPARATUS FOR FIXTURING A FERRULE OF A FIBER OPTIC CONNECTOR DURING END FACE POLISHING

(71) Applicant: CORNING RESEARCH & DEVELOPMENT CORPORATION, CORNING, NY (US)

(72) Inventors: Jesse Michael Groover, Newton, NC (US); David Wayne Howard, Granite Falls, NC (US); Zhiye Zhang, Hickory, NC (US)

(21) Appl. No.: 19/664,308

(22) Filed: Apr. 30, 2026

Related U.S. Application Data
(60) Provisional application No. 63/803,998, filed on May 12, 2025.

(51) Int. Cl. G02B 6/38; G02B 6/25

(52) U.S. Cl. CPC G02B 6/3858; G02B 6/25

(57) ABSTRACT

A clamp mechanism for a polishing fixture includes a headpiece connected to an actuator arm of the polishing fixture that applies a clamping force P through a central contact point of the headpiece. The headpiece includes a first pusher having a first contact site for engaging and a second pusher having a second contact site for engaging with the ferrule. The first contact site and the second contact site define a reference point. The reference point is located a first distance d_{A} from the first contact site and a second distance d_{B} from the second contact site. The clamping force P results in a first clamping force P_{A} at the first contact site and a second clamping force P_{B} at the second contact site. The central contact point is selected so a moment analysis about the central contact point is substantially balanced.

### PRIORITY CLAIM

This application claims the benefit of priority of U.S. Provisional Patent Application Ser. No. 63/803,998 filed on May 12, 2025, the content of which is relied upon and incorporated herein by reference in its entirety.

### TECHNICAL FIELD

This disclosure relates generally to fiber optic connectivity, and more particularly to an apparatus for clamping a ferrule of a fiber optic connector to a fixture in a predetermined location during polishing of the ferrule end face.

### BACKGROUND

Optical fibers are useful in a wide variety of applications, including the telecommunications industry for voice, video, and data transmissions. Benefits of optical fibers include wide bandwidth and low noise operation. In a telecommunications system that uses optical fibers, there are typically many locations where fiber optic cables containing the optical fibers connect to equipment or other fiber optic cables. To conveniently provide these connections, fiber optic connectors are often provided on the ends of fiber optic cables to non-permanently connect and disconnect optical elements in the fiber optic network. The process of terminating individual optical fibers from a fiber optic cable is referred to as “connectorization.” Connectorization can be done in a factory, resulting in a “pre-connectorized” or “pre-terminated” fiber optic cable, or the field (e.g., using a “field-installable” fiber optic connector).

The introduction of fiber optic connectors, however, may introduce insertion losses across an optical connection, e.g., at the junction between two or more optical fibers. The optical surface conditions of two mated optical fibers may contribute to insertion losses. To minimize insertion losses from the optical surface conditions, processes have been developed for optimizing the geometry and cleanliness of the optical fiber end faces.

A fiber optic connector typically includes a ferrule having one or more bores for receiving the optical fibers carried by the fiber optic cable. The ferrule holds the ends of the optical fiber and includes a ferrule end face for presentation of the ends of the optical fibers for optically communicating with corresponding optical fibers across the optical connection. The fiber optic connector further includes a connector housing assembly (also referred to as a connector body) which is configured to receive the ferrule within the housing assembly. The connector housing assembly is configured to mate with an optical device (e.g., adapter, equipment port, etc.) so that the ferrule, and more particularly the end faces of the one or more optical fibers received therein, is accurately positioned at a predetermined location. The optical fibers across the connection interface are similarly accurately positioned at a predetermined location such that misalignments of the optical fibers across the optical connection, and the resulting insertion losses, are minimized.

As noted above, optical losses across an optical connection may be introduced by defects and debris at the end faces of the ferrule and optical fibers of the fiber optic connectors. To avoid such optical losses, the end faces of the ferrule and optical fibers in a fiber optic connector may be subjected to a number of processes to ensure a desired end face geometry and desired level of cleanliness. For example, during manufacture of the fiber optic connector, the optical fibers are inserted into the respective bores in the ferrule such that a small length of fiber extends beyond the end face of the ferrule. The optical fibers are then secured to the ferrule, such as by applying an adhesive within the bores. Subsequently, the ferrule end face is subjected to a polishing process. The polishing process aids in providing the desired end face geometry and in removing certain defects from the end faces of the optical fibers and the end face of the ferrule, such as scratches, pits, digs, as well as adhesives and contaminates, to provide a clean, well-defined mating interface.

It is important that the polishing step of the connectorization process maintains/achieves the desired precise geometry of the ferrule/fiber end faces. Indeed, in many cases, the optical fiber and ferrule end faces must conform to relevant industry standards that specify requirements for different physical contact geometries. Examples of physical contact geometries known in the industry include, but are not limited to, physical contact (PC), angled physical contact (APC), and ultra physical contact (UPC) geometries. Thus, the challenge is to polish down the protrusions of the optical fibers from the ferrule end face to an acceptable height (e.g., within 50 microns of the ferrule end face) and to polish out defects in the optical fibers and ferrule in a manner that does not alter the end face geometry. This may be achieved, for example, by engaging the ferrule/fiber end faces with an abrasive element, which may take the form of an abrasive sheet or film, or an abrasive slurry.

Various ferrule polishing fixtures have been developed to fixate or hold the ferrule in a precise and predetermined position relative to the fixture when polishing the end faces of the ferrule and optical fibers. Such fixtures typically include a port that receives the ferrule and a clamp mechanism that applies forces to the ferrule in order to clamp the ferrule at the predetermined location within the port of the fixture. In this regard, the fixture port typically includes a plurality of reference datums that engage with corresponding reference datums on the ferrule when acted upon by the clamp mechanism. Once the ferrule is securely clamped in its precise, predetermined location within the port of the fixture, polishing the end face of the ferrule and optical fibers may commence. The forces imposed by the clamp mechanism on the ferrule must be of sufficient magnitude to prevent the ferrule from moving within the port and away from its predetermined location during polishing.

While current polishing fixtures are generally successful for current ferrule designs, the continued reduction in size of optical fibers, fiber optic cables, and fiber optic connectors, including ferrules of the fiber optic connectors, presents certain challenges in fixturing the ferrules during polishing. In this regard, due to their decreased size, the ferrules for more recent very small form factor fiber optic connectors are difficult to accurately clamp, and therefore difficult to position in a precise, predetermined location within the port of the fixture. Because in many cases the ferrule is not precisely positioned within the port, the polishing process results in the geometries of the end faces of the ferrule and optical fibers being different from their desired geometries. This, in turn, leads to increased insertion losses across the optical connection.

In view of the above, there is a need in the telecommunications industry for a clamp mechanism that precisely locates ferrule, including very small form factor ferrules, within a port such that desired geometries are achieved during polishing.

### SUMMARY

In one aspect of the disclosure, a clamp mechanism for securing a ferrule of a fiber optic connector to a polishing fixture during a polishing process is disclosed. The polishing fixture includes a moveable actuator arm, and the clamp mechanism includes a headpiece configured to be connected to the moveable actuator arm of the polishing fixture. The actuator arm is configured to apply a clamping force P through a central contact point of the headpiece to clamp the ferrule to the polishing fixture. The headpiece includes a first pusher having a first contact site for engaging with a first face of the ferrule and a second pusher having a second contact site for engaging with a second face of the ferrule. The first contact site of the first pusher defines a first tangent line and the second contact site of the second pusher defines a second tangent line that intersects the first tangent line at a reference point configured to coincide with the intersection of the first face and the second face of the ferrule. The reference point is located a first distance d_{A} from the first contact site of the first pusher and a second distance d_{B} from the second contact site of the second pusher. The actuator arm clamping force P is configured to result in a first clamping force P_{A} at the first contact site acting on the first face of the ferrule and a second clamping force P_{B} at the second contact site acting on the second face of the ferrule. The central contact point is positioned on the headpiece such that a moment analysis of the first clamping force P_{A} and the second clamping force P_{B} about the central contact point is substantially balanced.

In one embodiment, the headpiece may include a generally spherical socket configured to receive an end of the actuator arm and the central contact point may be defined on a surface of the socket. In one embodiment, for example, the end of the actuator arm may define a ball such that the headpiece and actuator arm connect at a ball and socket joint. This allows the headpiece to rotate relative to the actuator arm. In one embodiment, the movable actuator arm generally defines a movement axis, and the central contact point may be defined at the intersection of the movement axis and the surface of the socket. The central contact point may be considered the point at which the actuator arm clamping force P acts on the headpiece. Moreover, the central contact point may also be the point about which a moment analysis on the headpiece may be taken to determine whether the headpiece is balanced on the ball of the actuator arm or whether the headpiece is in an unbalanced state and will rotate during the polishing process.

In one embodiment, the polishing fixture may be configured such that the actuator arm acts through the central contact point at a machine angle θ_{P} and the end face of the ferrule is configured to have a polished ferrule end face target angle α. Additionally, the clamping force P_{A} may be configured to act a distance L_{A} from the central contact point and the clamping force P_{B} may be configured to act a distance L_{B} from the central contact point. In this embodiment, the central contact point may be selected so that:

$$\frac{{L}_{B}}{{L}_{A}} = \frac{cos ( {θ}_{P} - α )}{sin ( {θ}_{P} - α )}$$

In one specific embodiment, for example, the polishing fixture may be configured such that the machine angle θ_{P} is about 40°, the ferrule end face target angle α is about 8°, and the ratio L_{B}/L_{A} is about 1.6.

In one embodiment, the first contact site may be defined by a first arcuate surface. Additionally, the second contact surface may be defined by a second arcuate surface. For example, in one embodiment, the radius of curvature of the first arcuate surface may be greater than the radius of curvature of the second arcuate surface. The arcuate surfaces provide enhanced stability during the clamping of the ferrule in the polishing fixture during a polishing process.

In one embodiment, the first distance d_{A} and the second distance d_{B} may be selected so that during the polishing process a counterclockwise moment difference (M_{cc}−M_{c}) about a front pivot point of the polishing fixture is in the range of 10 N-mm and 30 N-mm. In this embodiment, the first distance d_{A} and the second distance d_{B} may also be selected so that during the polishing process a clockwise moment difference (M_{c}−M_{cc}) about a rear pivot point of the polishing fixture is in the range of 10 N-mm and 30 N-mm. This ensures that perturbations during the polishing process do not cause the position of the ferrule within the polishing fixture to become unstable and shift the ferrule to a slightly different position within the fixture, thereby avoiding errors in the ferrule end face angle due to position deviations.

In another aspect of the disclosure, a fixture for polishing a ferrule of a fiber optic connector is disclosed. The fixture includes a fixture port configured to receive the ferrule therein, at least one actuator arm moveable relative to the fixture port, and at least one clamp mechanism according to the first aspect of the disclosure described above connected to the at least one actuator arm for clamping the ferrule in the fixture port during polishing of the ferrule.

In yet a further aspect of the disclosure, a method of making a clamp mechanism for securing a ferrule of a fiber optic connector to a polishing fixture during a polishing process is disclosed. The method includes providing a clamp mechanism blank, forming from the clamp mechanism blank a headpiece, and forming on the headpiece a connection site configured to receive a moveable actuator arm of the polishing fixture, the actuator arm being configured to apply a clamping force P through a central contact point of the headpiece. The method further includes forming on the headpiece a first pusher having a first contact site for engaging with a first face of the ferrule and forming on the headpiece a second pusher having second contact site for engaging with a second face of the ferrule. The first contact site of the first pusher defines a first tangent line, and the second contact site of the second pusher defines a second tangent line that intersects the first tangent line at a reference point configured to coincide with the intersection of the first face and the second face of the ferrule. The reference point is located a first distance d_{A} from the first contact site of the first pusher and a second distance d_{B} from the second contact site of the second pusher. During the polishing process, the actuator arm clamping force P is configured to result in a first clamping force P_{A} at the first contact site acting on the first face of the ferrule and a second clamping force P_{B} at the second contact site acting on the second face of the ferrule. The method further includes selecting the central contact point such that a moment analysis of the first clamping force P_{A} and the second clamping force P_{B} about the central contact point is substantially balanced.

In one embodiment, the method may further include forming in the headpiece a generally spherical socket configured to receive an end of the actuator arm, and wherein the central contact point is defined on a surface of the socket. In one embodiment, the movable actuator arm may define a movement axis, and the central contact point may be defined at the intersection of the movement axis and the surface of the socket.

In one embodiment, the actuator arm is configured to act through the central contact point at a machine angle θ_{P}, the polishing fixture is configured to provide a polished ferrule end face target angle α, the clamping force P_{A} is configured to act a distance L_{A} from the central contact point, and the clamping force P_{B} is configured to act a distance L_{B} from the central contact point. Selecting the central contact point may include selecting the central contact point so that:

$$\frac{{L}_{B}}{{L}_{A}} = \frac{cos ( {θ}_{P} - α )}{sin ( {θ}_{P} - α )} .$$

In one embodiment, for example, the polishing fixture may be configured such that the machine angle θ_{P} is about 40°, the ferrule end face target angle α is about 8°, and the ratio L_{B}/L_{A} is about 1.6.

In one embodiment, forming the first pusher may further include forming a first arcuate surface to define the first contact site. Additionally, in one embodiment, the method may include forming a second arcuate surface to define the second contact site. In this embodiment, the method may include forming the first arcuate surface and forming the second arcuate surface such that a radius of curvature of the first arcuate surface is greater than a radius of curvature of the second arcuate surface.

In one embodiment of the method, selecting the first distance d_{A} and the second distance d_{B} may further include selecting the first distance d_{A} and the second distance d_{B} such that during use of the clamping mechanism in the polishing fixture, a counterclockwise moment difference (M_{cc}−M_{c}) about a front pivot point of the polishing fixture is in the range of 10 N-mm and 30 N-mm. Moreover, in one embodiment of the method, selecting the first distance d_{A} and the second distance de may further include selecting the first distance d_{A} and the second distance d_{B} such that during use of the clamping mechanism in the polishing fixture, a clockwise moment difference (M_{c}−M_{cc}) about a rear pivot point of the polishing fixture is in the range of 10 N-mm and 30 N-mm.

Additional features and advantages will be set forth in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a schematic view of a headpiece of a clamp mechanism engaging a ferrule disposed in a polishing fixture.

FIG. 2 is a free body diagram showing the forces acting on the ferrule of FIG. 1 with a pivot point on a front corner of the polishing fixture.

FIG. 3 is a decomposition of the actuator arm force P resulting in a clamping force P_{A} and a clamping force P_{B}.

FIG. 4 is a graph showing how the headpiece's location relative to the ferrule impacts the ferrule's rotational stability where the cant is less than 8 degrees.

FIG. 5 is a free body diagram showing the forces acting on the ferrule of FIG. 1 with a pivot point on a rear corner of the polishing fixture.

FIG. 6 is a graph showing how the headpiece's location relative to the ferrule impacts the ferrule's rotational stability where the tilt is greater than 8 degrees.

FIG. 7 is a schematic view of a headpiece according to one embodiment of the disclosure engaging a ferrule disposed in a polishing fixture.

FIG. 8 is a schematic similar to FIG. 7 illustrating the position of the central contact point for a balanced headpiece.

### DETAILED DESCRIPTION

The exemplary embodiments described herein are provided for illustrative purposes and are not limiting. Other exemplary embodiments are possible, and modifications may be made to the exemplary embodiments within the scope of the present disclosure. Therefore, the description below is not meant to limit the scope of the present disclosure. In general, the description relates to a clamping mechanism for securing a ferrule of a fiber optic connector to a polishing fixture during end face polishing. The clamping mechanism includes a headpiece with two pushers for engaging the ferrule. The two pushers are positioned at predetermined locations to minimize undesired shifting of the ferrule within the polishing fixture during the polishing process. By minimizing the shifting of the ferrule within the polishing fixture, the end face of the ferrule may be polished at a desired target polishing angle with minimal variation. The manufacturing yield rates of the ferrules, and the fiber optic connectors utilizing the ferrules, increases when there is minimal variation from the desired target angle.

In embodiments described below, this may be achieved at least in part by strategically locating the two pushers on the headpiece so that a moment analysis about a central contact point is substantially balanced and rotations of the ferrules and headpiece are minimized. In addition to the above, minimizing the shifting of the ferrule may be achieved at least in part by strategically locating the two pushers on the headpiece such that during a polishing process, moment analyses at front and rear points between the ferrule and the polishing fixture encourage the ferrule to remain seated against the fixture. Furthermore, minimizing the shifting of the ferrule may be achieved at least in part by defining the two pushers on the headpiece as arcuate surfaces. These and other aspects of the present disclosure are described in more detail below.

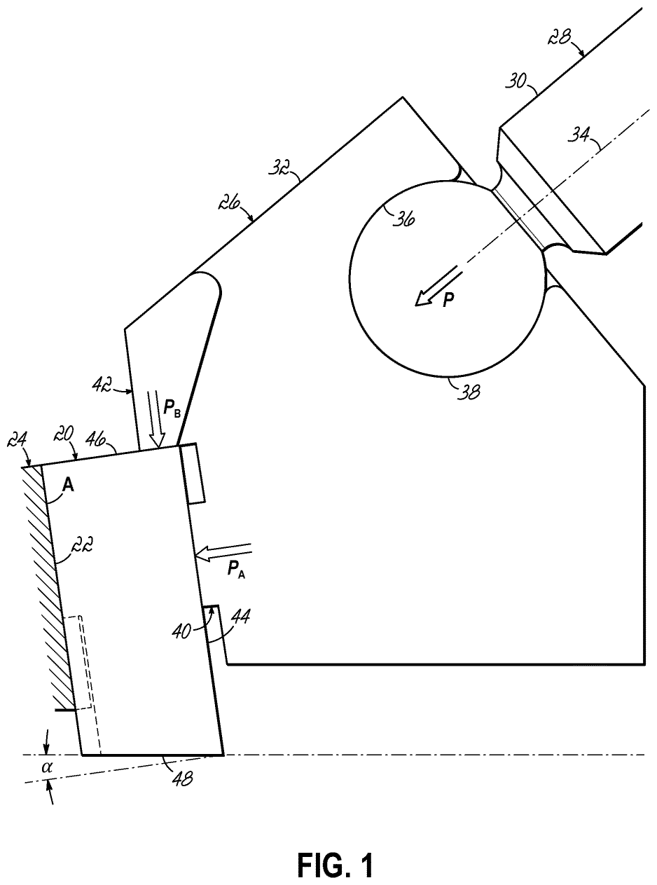

Ferrules, such as small form factor ferrules or very small form factor ferrules, may be used to produce fiber optic connectors, such as high-density fiber optic connectors. During the manufacturing process, the end face of a ferrule may be polished in a polishing fixture. FIG. 1 schematically illustrates a ferrule 20 engaged with a port 22 of a polishing fixture 24 according to a known system. The polishing fixture 24 may also include at least one clamp mechanism 26 having a linear actuator 28 with an actuator arm 30 and a headpiece 32. In one embodiment, the actuator arm 30 is extendable and retractable along an actuator arm axis 34 under operation of a motive force generator (not shown) operatively coupled to the actuator arm 30. The headpiece 32 is configured to be coupled to an end of the actuator arm 30 and engage against the ferrule 20 during use. The headpiece 32 may include a socket 36 and the distal end of the actuator arm 30 may include a ball 38 configured to be received in the socket 36. The socket 36 has a generally arcuate shape that matches the arcuate shape of the ball 38. This arrangement allows the headpiece 32 to rotate about the ball 38 within the socket 36. The headpiece 32 may include a first pusher 40 and a second pusher 42 for engaging against the ferrule 20. As illustrated in FIG. 1, in operation, the first pusher 40 is configured to contact a first face 44 of the ferrule 20 and the second pusher 42 is configured to contact a second face 46 of the ferrule 20.

The actuator arm 30 may apply an actuator arm clamping force P aligned with the actuator arm axis 34 to the headpiece 32. The actuator arm force P imposes clamping forces P_{A} and P_{B} on the ferrule 20 through the first and second pushers 40, 42, respectively. The clamping forces P_{A} and P_{B} are configured to push or hold the ferrule 20 against a datum surface A of the polishing fixture 24 such that an end face 48 of the ferrule 20 is held at a target angle α relative to a horizontal plane. The target angle α is configured to match the desired end face angle of the ferrule 20. In one embodiment, for example, the target angle may be about 8°. It should be recognized, however, that the target angle α may have a different value depending on the desired end face angle of the ferrule 20.

In practice, however, the clamp mechanism 26 shown in FIG. 1 may be unable to secure the ferrule 20 to the polishing fixture 24 such that the target angle α is consistently achieved. For example, when the desired target angle is 8°, it has been discovered that the resulting angle of the ferrule end face 48 is consistently less than 8° and is only barely able to meet the lower end of the allowed tolerance for the end face angle of the ferrule 20. It has further been discovered that the source of this result is an undesired shift in the engagement between the headpiece 32 and the ferrule 20. More particularly, it has been discovered that in many cases the ferrule 20 cants relative to the headpiece 32 such that ferrule 20 contacts the first pusher 40 near the front or rear corner of the first pusher 40. Thus, instead of having area contact between the (e.g., upper surface) of the first pusher 40 and the ferrule 20, the ferrule 20 is being supported by the headpiece 32 in essentially line contact at the front or rear corner of the first pusher 40. This shifting between the ferrule 20 and the headpiece 32, and the resultant movement of the contact locations therebetween, causes the ferrule's location to deviate from its intended position within the polishing fixture 24. Accordingly, at the end of the polishing process, the angle of the end face 48 of the ferrule 20 deviates from its intended end face angle.

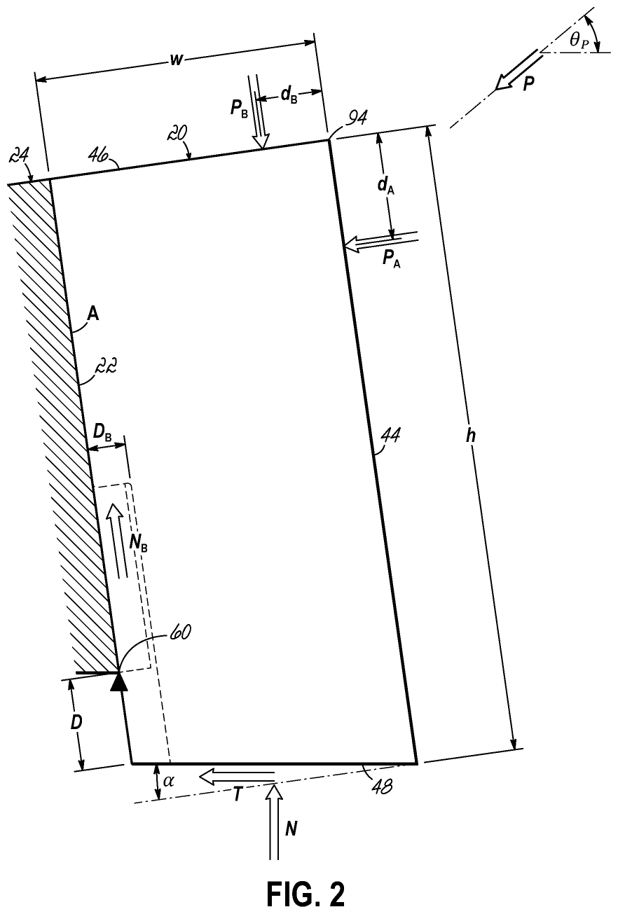

To better understand the undesired shifting between the ferrule 20 and the headpiece 32, a moment balance analysis may be conducted for two different conditions. The first condition is where the ferrule 20 is canting towards less than the target angle (e.g., 8°) and a second condition where the ferrule 20 is canting towards greater than the target angle. In this regard, FIG. 2 shows a free body diagram of the ferrule 20 engaging the polishing fixture 24 along the datum surface A with a front pivot point 60 at the bottom of the datum surface A. The free body diagram is acted on by at least five separate forces, P_{A}, P_{B}, N_{B}, N, and T. Table 1 defines the various variables identified on the free body diagram.

TABLE 1
List of Variables in Free Body Diagram

| | |
|---|---|
| P | total clamping force on ferrule from the clamp |
| P_{B} | clamping force on datum B from the clamp |
| P_{A} | clamping force on datum A from the clamp |
| N_{B} | supporting force on datum B from base |
| T | shear force at polishing |
| N | normal force at polishing |
| d_{B} | distance of P_{B} from ferrule surface opposite to datum A |
| | (nominal 0.467 mm, varies in polishing) |
| d_{A} | distance of P_{A} from ferrule top surface |
| D_{B} | datum B depth on ferrule |
| w | ferrule width |
| h | ferrule height, measured at the surface opposite to datum A |
| D | ferrule protrusion out of base |
| θ_{P} | ball joint shaft angle with the ferrule bottom end face |
| α | ferrule end face angle |

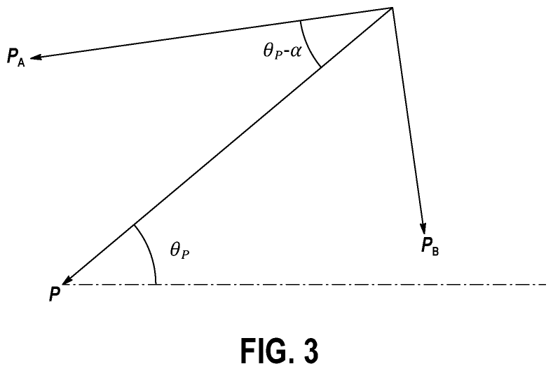

The actuator arm clamping force P may be decomposed into clamping forces P_{A}, P_{B} as shown in FIG. 3. The angles α and θₚ are defined relative to the ferrule 20 and the actuator arm clamping force P as shown in FIG. 3. As discussed above, when the desired target angle is 8°, the resulting angle of the end face 48 is consistently less than 8°. When the target angle α is less than desired, the ferrule 20 is canted clockwise about pivot point 60 as shown in FIG. 2. The moment balance of the ferrule 20 under clamping about the pivot point 60 may be determined. The forces P_{A} and P_{B} may be determined from actuator arm clamping force P as shown in Equations 1 and 2.

P_{A}=P cos(θ_{P}−α) (1)

P_{B}=P sin(θ_{P}−α) (2)

The force N_{B} is shown in Equation 3.

N_{B}=P_{B}−N cos α−T sin α (3)

The clockwise moment around the pivot point 60 in FIG. 2 is shown in Equation 4.

M_{C}=TD cos α+P_{B}(w−d_{B}) (4)

The counterclockwise moment around pivot point 60 is shown in Equation 5.

$${M}_{CC} = N ( \frac{w}{2 cos α} + D sin α ) + {P}_{A} ( h - w tan α - D - {d}_{A} ) + \frac{{N}_{B} {D}_{B}}{2} \qquad ( 5 )$$

The counterclockwise moment M_{cc} is responsible for maintaining the orientation of the ferrule 20 against the datum surface A of the polishing fixture 24. If the clockwise moment M_{c}, however, is relatively close to M_{cc}, any perturbation during polishing, such as a vibration, dynamic effect, and frictional forces, may cause the ferrule 20 to cant or tilt away from the datum surface A. The difference between M_{cc} and M_{c}, referred to as a counterclockwise moment difference, is a measure of the rotational stability of the ferrule 20 within the polishing fixture 24. The greater the difference, with M_{cc} being larger than M_{c}, the more stable the ferrule 20 will be during the polishing process.

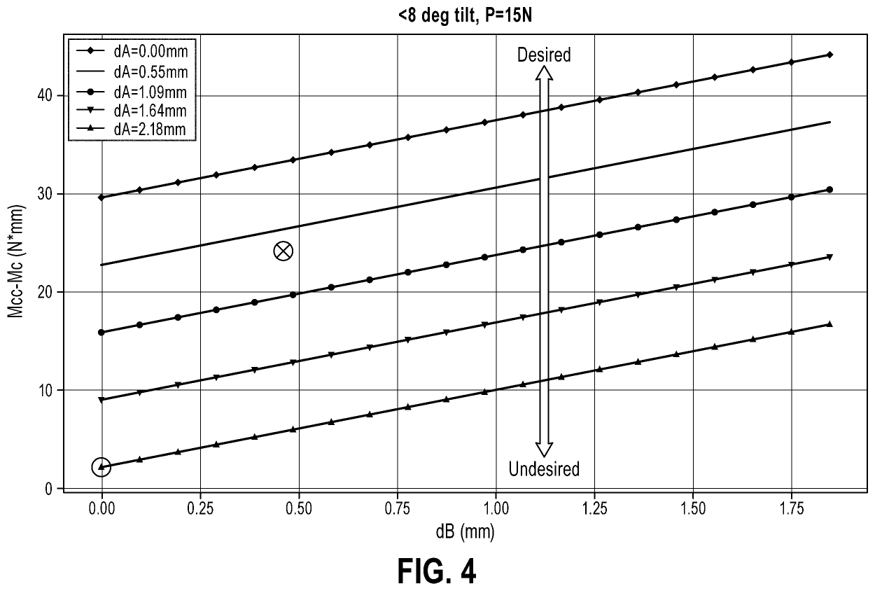

The location of the first and second pushers 40, 42 on the first and second faces 44, 46 may play a significant role in determining the stability of the ferrule 20. FIG. 4 plots how the counterclockwise moment difference (M_{cc}−M_{c}) changes as a function of the distance d_{B} for five different fixed d_{A}'s. FIG. 4 is for the ferrule 20 canting towards less than 8°. The circled X in FIG. 4 represents d_{A}=0.77 mm and d_{B}=0.467 mm, which may be considered a nominal design. At the nominal design, M_{cc} is greater than M_{c} by more than 20 N*mm. However, as was discussed above, as the ferrule 20 shifts in the headpiece 32, the first and second pushers 40, 42 may move relative to the first and second faces 44, 46 and thus, the distances d_{A} and d_{B} may change. Consequently, the difference between M_{cc} and M_{c} may become very small, causing the ferrule 20 to be more susceptible to canting during the polishing process. To maximize the stability of the ferrule 20 and minimize the risk of canting during polishing, the clamping locations, i.e., d_{A} and d_{B} should remain substantially constant even when the headpiece 32 shifts.

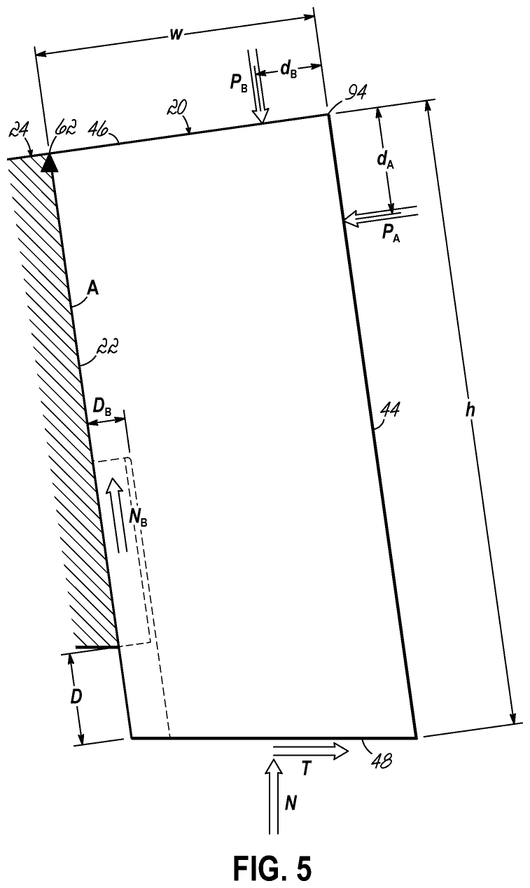

The analysis above is for the ferrule 20 rotating clockwise during polishing, but the analysis should also consider for the ferrule 20 rotating counterclockwise during polishing. When rotating in the counterclockwise direction, the ferrule pivots about a rear pivot point 62 as shown in FIG. 5. FIG. 5 shows a free body diagram of the ferrule 20 engaging the polishing fixture 24 along the datum surface A with the rear pivot point 62 at the top of the datum surface A. The free body diagram is acted on by the same forces P_{A}, P_{B}, N_{B}, N, and T that are acting in FIG. 2, but force T is acting in the opposite direction. Force N_{B} is defined above in Equation 3.

The clockwise moment around pivot point 62 in FIG. 5 is shown in Equation 6.

M_{C}=P_{A}d_{A}+P_{B}(w−d_{B}) (6)

The counterclockwise moment around pivot point 62 is shown in Equation 7.

$${M}_{CC} = N ( \frac{w}{2 cos α} + ( h - w tan α ) sin α ) + T ( h - w tan α ) cos α + \frac{{N}_{B} {D}_{B}}{2} \qquad ( 7 )$$

The clockwise moment M_{c} is responsible for maintaining the orientation of the ferrule 20 against the datum surface A of the polishing fixture 24. If the counterclockwise moment M_{cc}, however, is relatively close to M_{c}, any perturbation during polishing, such as a vibration, dynamic effect, and frictional forces, may cause the ferrule 20 to cant or tilt away from the datum surface A. The difference between M_{c} and M_{cc}, referred to as a clockwise moment difference, is a measure of the rotational stability of the ferrule 20 within the polishing fixture 24. The greater the difference, with M_{c} being larger than M_{cc}, the more stable the ferrule 20 will be during the polishing process.

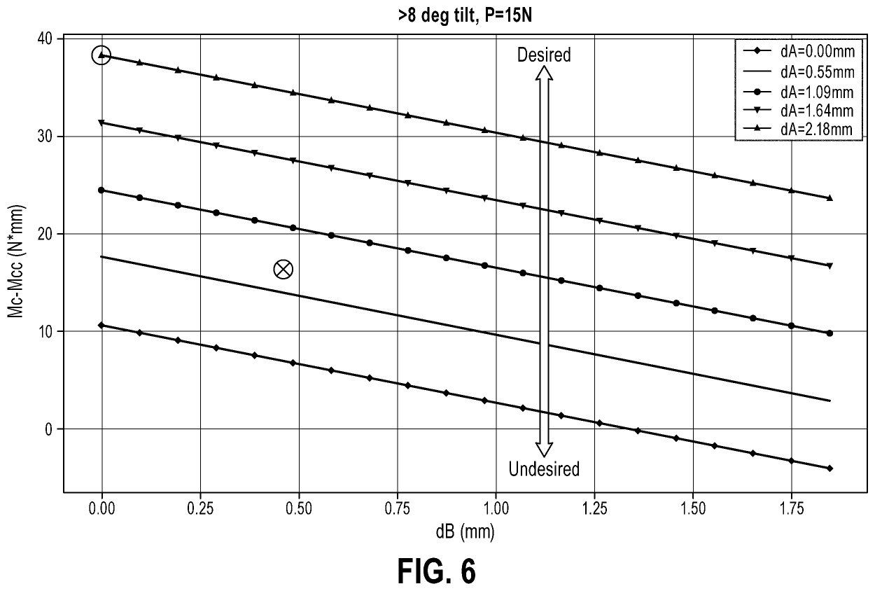

Like above, the locations of the first and second pushers 40, 42 on the first and second faces may play a significant role in determining the stability of the ferrule 20. FIG. 6 plots how the clockwise moment difference (M_{c}−M_{cc}) changes as a function of the distance d_{B} for five different fixed d_{A}'s. FIG. 6 is for the ferrule 20 shifting towards greater than 8°. The circled X in FIG. 6 represents d_{A}=0.77 mm and d_{B}=0.467 mm, which may be considered the nominal design as noted above. At the nominal design, M_{c} is greater than M_{c} by approximately 18 N*mm. FIGS. 4 and 6 may help determine the optimal contact locations for the forces P_{A} and P_{B}.

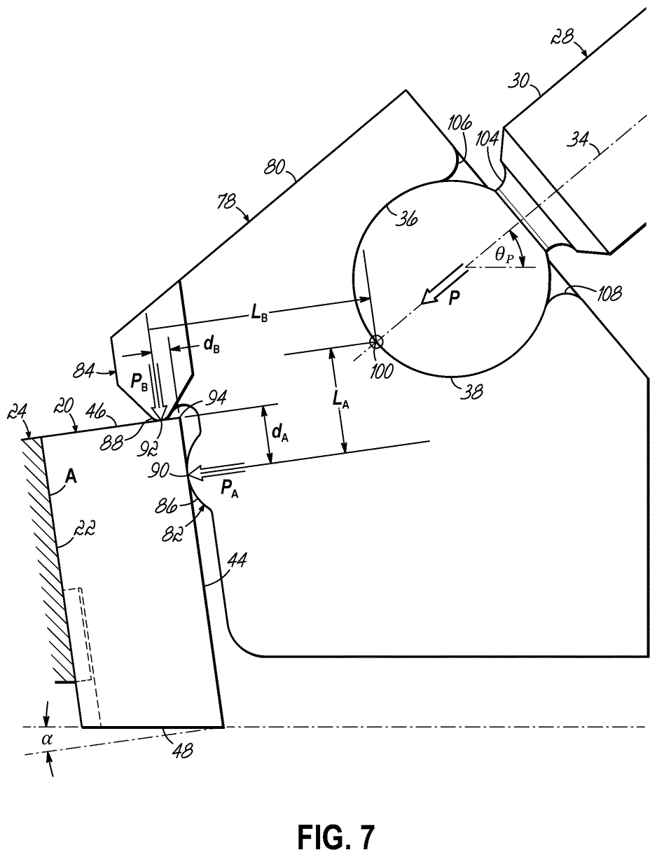

FIG. 7 shows clamp mechanism 78 with a headpiece 80 according to one embodiment of the disclosure. The headpiece 80 includes a first pusher 82 and a second pusher 84. The first pusher 82 includes an arcuate portion 86 defining a contact site 90 adapted to contact the first face 44 of the ferrule 20. Similarly, the second pusher 84 includes an arcuate portion 88 defining a contact site 92 adapted to contact the second face 46 of the ferrule 20 at a contact point 92. Due to the planar, box-like construction of the ferrule 20, the contact site 90 of the first pusher 82 generally defines a tangent line and the contact site 92 of the second pusher 84 generally defines a second tangent line extending perpendicular to the first tangent line so as to intersect the first tangent line to thereby define a reference point along an edge 94 defined by the intersection of the first face 44 and the second face 46 of the ferrule 20.

The arcuate portions 86, 88 are in contrast to the flat contact surfaces of the first and second pushers 40, 42 on headpiece 32 shown in FIG. 1. In this regard, the arcuate configuration of the first pusher 82 and the second pusher 84 is configured to create line contact with the ferrule 20 as opposed to area contact. It is believed that line contact is more stable and allows small variations without relatively large shifts in ferrule position. Thus, it is believed that the flat contact surfaces of the pushers 40, 42 contribute to the headpiece 32 canting during the polishing process. In other words, it is believed that when the ferrule 20/headpiece 32 starts to shift, the corners of the first pusher 40 become the available “stability” points during the shifting. It is believed that with the arcuate portions 86, 88 properly located relative to the ferrule 20, the ferrule 20 remains stable even at slight deviations from the intended contact points on the first pusher 40. Because the engagement between the ferrule 20 and the headpiece 80 remains stable during shifting, large movements of the ferrule 20 (such as to the corners of the first pusher 40) are avoided and the target angle α may be more consistently achieved during polishing. In one embodiment, the radius of the arcuate portion 86 may be the same as the radius of the arcuate portion 88. In another embodiment, however, the radius of curvature of the arcuate portion 86 may be less than the radius of curvature of the arcuate portion 88. In a further embodiment, and as illustrated in the figures, the radius of curvature of the arcuate portion 86 may be greater than the radius of the arcuate portion 88.

In one embodiment, FIG. 4 may be used to optimize the location the contact points 90, 92 to ensure rotational stability of the ferrule and provide resilience to perturbations during the polishing process. FIG. 4 may be selected since empirical data suggests that canting of the ferrule 20 within the polishing fixture 24 mainly occurs towards less than 8° (as opposed to that shown in FIG. 6). In addition, the arcuate portions 86, 88 provide a balanced force within the oscillation scope of the ball 38 in the socket 36, which may depend on various factors, such as shaft axis angle, i.e., θ_{P} (FIG. 2), the applied actuator arm clamping force P, and the design of the ball 38 and socket 36.

FIG. 7 shows the applied actuator arm clamping force P acting along the actuator arm axis 34. The actuator arm axis 34 goes through a central contact point 100 located in the middle of the arc of the socket 36. The applied actuator arm clamping force P may be broken down into the clamping forces P_{A} and P_{B} that act through the contact points 90, 92. The clamping forces P_{A} and P_{B} act perpendicular to the first and second faces 44, 46, respectively. A distance L_{A} is the perpendicular distance the clamping force P_{A} acts from the central contact point 100 and a distance L_{B} is the perpendicular distance the clamping force P_{B} acts from the central contact point 100.

In addition to the above, a moment analysis may be completed for the clamp mechanism 78 illustrated in FIG. 7. In this regard, while the linear forces P, P_{A}, and P_{B} are balanced, the rotational equilibrium of those forces should also be evaluated. In this regard, if the moments are substantially balanced, then the headpiece 80 should not rotate or minimally rotate during the polishing process. As used herein, “substantially balanced” means that the moment in the clockwise direction and the moment in the counterclockwise direction differ by less than 5%, and preferably less than about 3%. If the moments are not balanced, however, the headpiece 80 may rotate on the ball 38 to reach equilibrium. In some cases, the headpiece 80 may rotate until there is contact between headpiece 80 and the actuator arm 30. This should be avoided during the polishing process. Thus, it is desirable to not only locate the first and second pushers 82, 84 to minimize canting during the polishing process but also locate the first and second pushers 82, 84 so as to balance the moments of the headpiece 80 about the ball 38. Equation 8 represents the rotational equilibrium when analyzed about the central contact point 100.

P_{B}·L_{B}=P_{A}·L_{A} (8)

The distances L_{A}, L_{B} may be determined by the shaft axis angle θ_{P} and the target angle α. Equation 9 shows the relationship between the distance L_{A} and the distance L_{B} and the shaft axis angle θ_{P} and the target angle α.

$$\frac{{L}_{B}}{{L}_{A}} = \frac{{P}_{A}}{{P}_{B}} = \frac{cos ( {θ}_{P} - α )}{sin ( {θ}_{P} - α )} \qquad ( 9 )$$

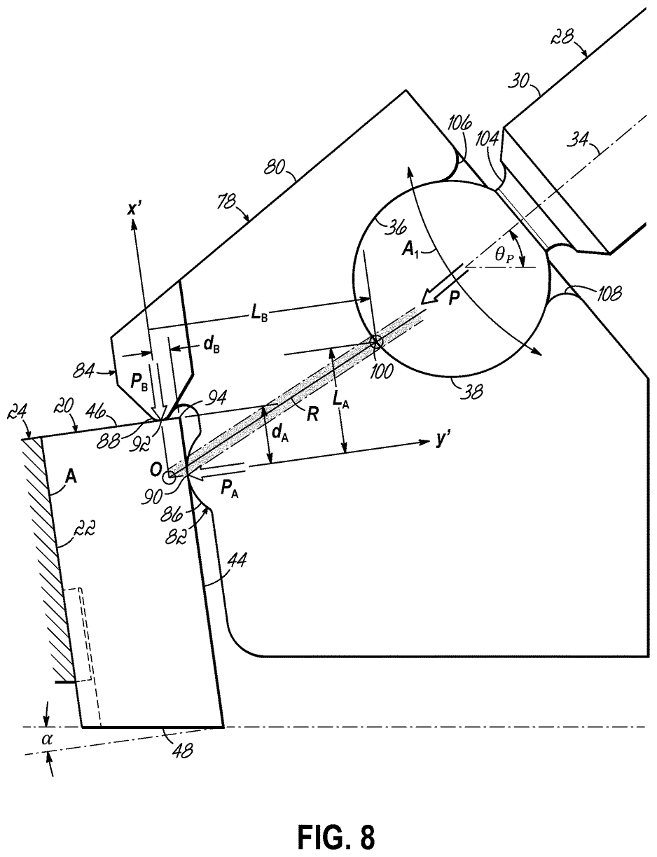

In an embodiment, the shaft axis angle θ_{P} may be about 40° and the target angle α may be about 8°. Those values may be substituted into Equation 9 such that the ratio of L_{B}/L_{A} is approximately 1.6. FIG. 8 illustrates the geometry of the headpiece 80 similar to FIG. 7. The contact site 90 of the first pusher 82 generally defines a first perpendicular line and the contact site 92 of the second pusher 84 generally defines a second perpendicular line extending orthogonally to the first perpendicular line so as to intersect the first perpendicular line to thereby define an origin of a Cartesian coordinate system x′, y′. There is a line LN_{B} in the x′-y′ plane where the moment balance about the central contact point 100 is substantially zero. That line is characterized as going through the origin of the x′-y′ coordinate system and having a slope equal to the desired L_{B}/L_{A}:

$${y}^{′} = \frac{{L}_{B}}{{L}_{A}} {x}^{′} ; {y}^{′} = \frac{cos ( {θ}_{P} - α )}{sin ( {θ}_{P} - α )} {x}^{′} . \qquad ( 10 )$$

The line LN_{B} is shown in FIG. 8, and with the central contact point 100 located along that line, the moment balance about the central contact point 100 will be substantially zero.

The line LN_{B} is a theoretical line where the moments about the central con tact point 100 are balanced. However, because the headpiece 80 is able to pivot about the ball 38 for a small angle illustrated by arrow A₁, there is a band or region R about the line LN_{B} in which deviations of the central contact point 100 away from LN_{B} will allow the headpiece 80 to still adjust to a stable position. The outer bounds of this region R may be where the lower end 104 of the actuator arm 30 contacts the hard stops 106, 108 of the socket 36.

Thus, the distances L_{A}, L_{B} depend on the contact points 90, 92, which define distances d_{A}, d_{B} to the edge 94 of the ferrule 20. A longer distance d_{B} may be advantageous, but because of the physical construction of the ferrule 20 (i.e., the optical fibers extending from the rear end thereof), the distance d_{B} may be limited to shorter distances of about 0.5 mm. In one embodiment, the distance d_{B} may be 0.467 mm, which is a distance carried over from the headpiece 32. Designers have greater flexibility with the distance d_{A} due to a lack of physical limitations. In one embodiment, d_{A} may be selected to be about 1.2 mm. With d_{B} equal to 0.467 mm and d_{A} about 1.2 mm, both (M_{cc}−M_{c}) (see FIG. 4) and (M_{c}−M_{cc}) (see FIG. 6) are greater than about 18 N*mm, which is in an acceptable range to promote stability of the ferrule in both the counterclockwise and clockwise directions. Once those values are known, the location of the central contact point 100 may be determined from FIG. 8. Namely, a designer may locate the central contact point 100 in the region R in order to substantially balance the headpiece 80. In one embodiment, an L_{A} and L_{B} pair may be selected as L_{A}=1.81 and L_{B}=2.90 to achieve the ratio L_{B}/L_{A}≈1.6. Thus, the socket 36 may now be formed in the headpiece 80 at the desired location. These numbers are not necessarily unique. The paired values then determine how “deep” into the headpiece 80 the socket 36 is located.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The disclosure in its broader aspects is therefore not limited to the specific details, representative apparatus and methods and illustrative examples shown and described. Instead, it should be evident that departures may be made from such details without departing from the scope of the disclosure.

What is claimed is:

1. A clamp mechanism for securing a ferrule of a fiber optic connector to a polishing fixture during a polishing process, the polishing fixture having a moveable actuator arm, the clamp mechanism comprising:
a headpiece configured to be connected to the moveable actuator arm of the polishing fixture, the actuator arm configured to apply a clamping force (P) through a central contact point of the headpiece, the headpiece comprising:
a first pusher having a first contact site for engaging with a first face of the ferrule; and
a second pusher having a second contact site for engaging with a second face of the ferrule,
wherein the first contact site of the first pusher defines a first tangent line and the second contact site of the second pusher defines a second tangent line that intersects the first tangent line at a reference point configured to coincide with the intersection of the first face and the second face of the ferrule,
wherein the reference point is located a first distance (d_{A}) from the first contact site of the first pusher and a second distance (d_{B}) from the second contact site of the second pusher,
wherein the actuator arm clamping force (P) is configured to result in a first clamping force (P_{A}) at the first contact site acting on the first face of the ferrule and a second clamping force (P_{B}) at the second contact site acting on the second face of the ferrule, and
wherein the first distance (d_{A}), the second distance (d_{B}), and the central contact point are selected such that a moment analysis of the first clamping force (P_{A}) and the second clamping force (P_{B}) about the central contact point is substantially balanced.

2. The clamping mechanism of claim 1, wherein the headpiece includes a generally spherical socket configured to receive an end of the actuator arm, and wherein the central contact point is defined on a surface of the socket.

3. The clamping mechanism of claim 2, wherein the movable actuator arm defines a movement axis, and wherein the central contact point is defined at the intersection of the movement axis and the surface of the socket.

4. The clamping mechanism of claim 1, wherein:
the actuator arm is configured to act through the central contact point at a machine angle (θ_{P}),
the polishing fixture is configured to provide a polished ferrule end face target angle (α),
the clamping force (P_{A}) is configured to act a distance (L_{A}) from the central contact point, and the clamping force (P_{B}) is configured to act a distance (L_{B}) from the central contact point, and
the central contact point is selected so that
$$\frac{{L}_{B}}{{L}_{A}} = \frac{cos ( {θ}_{P} - α )}{sin ( {θ}_{P} - α )}$$

5. The clamping mechanism of claim 4, wherein the polishing fixture is configured such that the machine angle (θ_{P}) is about 40°, the ferrule end face target angle (α) is about 8°, and the ratio L_{B}/L_{A} is about 1.6.

6. The clamping mechanism of claim 1, wherein the first contact site is defined by a first arcuate surface.

7. The clamping mechanism of claim 1, wherein the second contact site is defined by a second arcuate surface.

8. The clamping mechanism of claim 7, wherein the first contact site is defined by a first arcuate surface, and wherein the radius of curvature of the first arcuate surface is greater than the radius of curvature of the second arcuate surface.

9. The clamping mechanism of claim 1, wherein the first distance (d_{A}) and the second distance (d_{B}) are selected so that a counterclockwise moment difference (M_{cc}−M_{c}) about a front pivot point of the polishing fixture is in the range of 10 N-mm and 30 N-mm.

10. The clamping mechanism of claim 1, wherein the first distance (d_{A}) and the second distance (d_{B}) are selected so that a clockwise moment difference (M_{c}−M_{cc}) about a rear pivot point of the polishing fixture is in the range of 10 N-mm and 30 N-mm.

11. A fixture for polishing a ferrule of a fiber optic connector, comprising:
a fixture port configured to receive the ferrule therein;
at least one actuator arm moveable relative to the fixture port; and
at least one clamp mechanism connected to the at least one actuator arm for clamping the ferrule in the fixture port during polishing of the ferrule, wherein the at least one clamp mechanism comprises:
a headpiece configured to be connected to an actuator arm of the at least one actuator arm of the polishing fixture, the actuator arm configured to apply a clamping force (P) through a central contact point of the headpiece, the headpiece comprising:
a first pusher having a first contact site for engaging with a first face of the ferrule; and
a second pusher having a second contact site for engaging with a second face of the ferrule,
wherein the first contact site of the first pusher defines a first tangent line and the second contact site of the second pusher defines a second tangent line that intersects the first tangent line at a reference point configured to coincide with the intersection of the first face and the second face of the ferrule,
wherein the reference point is located a first distance (d_{A}) from the first contact site of the first pusher and a second distance (d_{B}) from the second contact site of the second pusher,
wherein the actuator arm clamping force (P) is configured to result in a first clamping force (P_{A}) at the first contact site acting on the first face of the ferrule and a second clamping force (P_{B}) at the second contact site acting on the second face of the ferrule, and
wherein the first distance (d_{A}), the second distance (d_{B}), and the central contact point are selected such that a moment analysis of the first clamping force (P_{A}) and the second clamping force (P_{B}) about the central contact point is substantially balanced.

12. A method of making a clamp mechanism for securing a ferrule of a fiber optic connector to a polishing fixture during a polishing process, the method comprising:
providing a clamp mechanism blank;
forming from the clamp mechanism blank a headpiece;
forming on the headpiece a connection site configured to receive a moveable actuator arm of the polishing fixture, the actuator arm configured to apply a force (P) through a central contact point of the headpiece;
forming on the headpiece a first pusher having a first contact site for engaging with a first face of the ferrule; and
forming on the headpiece a second pusher having second contact site for engaging with a second face of the ferrule,
wherein the first contact site of the first pusher defines a first tangent line and the second contact site of the second pusher defines a second tangent line that intersects the first tangent line at a reference point configured to coincide with the intersection of the first face and the second face of the ferrule,
wherein the reference point is located a first distance (d_{A}) from the first contact site of the first pusher and a second distance (d_{B}) from the second contact site of the second pusher, and
wherein the actuator arm clamping force (P) is configured to result in a first clamping force (P_{A}) at the first contact site acting on the first face of the ferrule and a second clamping force (P_{B}) at the second contact site acting on the second face of the ferrule, and
selecting the central contact point such that a moment analysis of the first clamping force (P_{A}) and the second clamping force (P_{B}) about the central contact point is substantially balanced.

13. The method of claim 12, further comprising:
forming in the headpiece a generally spherical socket configured to receive an end of the actuator arm, and wherein the central contact point is defined on a surface of the socket.

14. The method of claim 13, wherein the movable actuator arm defines a movement axis, and wherein the central contact point is defined at the intersection of the movement axis and the surface of the socket.

15. The method of claim 12, wherein:
the actuator arm is configured to act through the central contact point at a machine angle (θ_{P}),
the polishing fixture is configured to provide a polished ferrule end face target angle (α),
the clamping force (P_{A}) is configured to act a distance (L_{A}) from the central contact point, and the clamping force (P_{B}) is configured to act a distance (L_{B}) from the central contact point, and
selecting the central contact point further comprises selecting the central contact point so that
$$\frac{{L}_{B}}{{L}_{A}} = \frac{cos ( {θ}_{P} - α )}{sin ( {θ}_{P} - α )}$$

16. The method of claim 15, wherein the polishing fixture is configured such that the machine angle (θ_{P}) is about 40°, the ferrule end face target angle (α) is about 8°, and the ratio L_{B}/L_{A} is about 1.6.

17. The method of claim 12, wherein forming the first pusher further comprises forming a first arcuate surface to define the first contact site, and wherein forming the second pusher further comprises forming a second arcuate surface to define the second contact site.

18. The method of claim 17, further comprising forming the first arcuate surface and forming the second arcuate surface such that a radius of curvature of the first arcuate surface is greater than a radius of curvature of the second arcuate surface.

19. The method of claim 12, wherein selecting the first distance (d_{A}) and the second distance (d_{B}) further comprises selecting the first distance (d_{A}) and the second distance (d_{B}) such that during use of the clamping mechanism in the polishing fixture, a counter clockwise moment difference (M_{cc}−M_{c}) about a front pivot point of the polishing fixture is in the range of 10 N-mm and 30 N-mm.

20. The method of claim 20, wherein selecting the first distance (d_{A}) and the second distance (d_{B}) further comprises selecting the first distance (d_{A}) and the second distance (d_{B}) such that during use of the clamping mechanism in the polishing fixture, a clockwise moment difference (M_{c}−M_{cc}) about a rear pivot point of the polishing fixture is in the range of 10 N-mm and 30 N-mm.
